(19) United States
(12) Patent Application Publication
(10) Pub. No.: US 2024/0310651 A1
(43) Pub. Date: Sep. 19, 2024

(54) REVERSIBLE FRAMES FOR SPECTACLES

(71) Applicant: Warby Parker Inc., New York, NY (US)

(72) Inventors: Adam Mendelsohn, Centerport, NY (US); James T. Fallon, New York, NY (US); Bo Zhao, Long Island City, NY (US)

(73) Assignee: Warby Parker Inc., New York, NY (US)

(21) Appl. No.: 18/122,377

(22) Filed: Mar. 16, 2023

(51) Int. Cl. G02C 5/20; G02C 5/22

(52) U.S. Cl. CPC G02C 5/20; G02C 5/2263; G02C 5/229; G02C 2200/06; G02C 2200/08; G02C 2200/22

(57) ABSTRACT

A frame comprises a front portion, connecting members, a first arm coupled to a first connecting member by a hinge, and a second arm coupled to a second connecting member by a hinge. The first and second connecting members are coupled to the front portion by hinges. The first arm is rotatable, relative to the first connecting member, about a first pivot axis, and the second arm is rotatable, relative to the second connecting member, about a second pivot axis. The first pivot axis and second pivot axis are parallel to each other and positioned at an angle relative to lengths of the first and second arms, respectively. The first and second connecting members are rotatable, relative to the front portion, about a third pivot axis, which is positioned at an angle relative to the first pivot axis and the second pivot axis.

### BACKGROUND

### Field

The present disclosure generally relates to eyewear, and more particularly to reversible frames for spectacles.

### Description of the Related Art

Eyeglass frames have long been designed hold a pair of corrective, filtering, or polarizing lenses in front of a wearer's eyes. The frame commonly includes a front portion that holds the lenses, and a pair of arms that extend from the front portion to rest between the wearer's head and ear. The arms are typically attached to the front portion by a hinge that allows the arms to pivot relative to the front portion, and thus to be folded against the front portion for compact storage of the eyeglasses.

However, it may be desirable to provide eyeglass frames with additional functionality and versatility.

### SUMMARY

The present disclosure provides reversible frames for spectacles. According to some aspects of the present disclosure, a frame for spectacles is disclosed. The frame comprises a front portion having at least one opening configured to hold a lens, a first connecting member, a second connecting member, a first temple arm, and a second temple arm. The first temple arm has a first end that is coupled to a first end of the first connecting member by a first hinge. The second temple arm has a first end that is coupled to a first end of the second connecting member by a second hinge. The first connecting member is coupled to a first end of the front portion by a third hinge, and the second connecting member is coupled to a second end of the front portion by a fourth hinge. The first temple arm is rotatable, relative to the first connecting member, about a first pivot axis, and the second temple arm is rotatable, relative to the second connecting member, about a second pivot axis. The first pivot axis and the second pivot axis are substantially parallel to each other and positioned at an angle relative to a length of the first temple arm and a length of the second temple arm, respectively. The first connecting member and the second connecting member are rotatable, relative to the front portion, about a third pivot axis. The third pivot axis is positioned at an angle relative to the first pivot axis and the second pivot axis.

In some embodiments, the front portion comprises a first side comprising a first pattern and a second side comprising a second pattern. In some embodiments, the first pattern and the second pattern are different. In some embodiments, the first connecting member and the second connecting member are configured to rotate 190-204 degrees about the third pivot axis. In some embodiments, the front portion has a pantoscopic tilt of 10 degrees in a first position. In some embodiments, the first hinge and the second hinge comprise one or more of integrated spring hinges, riveted hinges, and metal temples. In some embodiments, the third pivot axis is substantially perpendicular to the first pivot axis and the second pivot axis. In some embodiments, the first pivot axis and the second pivot axis are substantially perpendicular to the length of the first temple arm and the length of the second temple arm, respectively. In some embodiments, the third hinge comprises a pin comprising a center portion and an arm that protrudes from the center portion. The pin may be configured to be inserted into an opening at the first end of the front portion. The third hinge further comprises a protruding member in the opening at the first end of the front portion. The protruding member may be configured to stop rotation of the pin in a first direction when the arm contacts the protruding member. In some embodiments, the fourth hinge comprises a pin comprising a center portion and an arm that protrudes from the center portion. The pin is configured to be inserted into an opening at the second end of the front portion. The fourth hinge further comprises a protruding member in the opening at the second end of the front portion. The protruding member is configured to stop rotation of the pin in a first direction when the arm contacts the protruding member.

According to some aspects of the present disclosure, a pair of spectacles is disclosed. The pair of spectacles comprises at least one lens and a frame. The frame comprises a front portion having at least one opening configured to hold the at least one lens, a first connecting member, a second connecting member, a first temple arm, and a second temple arm. The first temple arm has a first end that is coupled to a first end of the first connecting member by a first hinge. The second temple arm has a first end that is coupled to a first end of the second connecting member by a second hinge. The first connecting member is coupled to a first end of the front portion by a third hinge, and the second connecting member is coupled to a second end of the front portion by a fourth hinge. The first temple arm is rotatable, relative to the first connecting member, about a first pivot axis, and the second temple arm is rotatable, relative to the second connecting member, about a second pivot axis. The first pivot axis and the second pivot axis are substantially parallel to each other and positioned at an angle relative to a length of the first temple arm and a length of the second temple arm, respectively. The first connecting member and the second connecting member are rotatable, relative to the front portion, about a third pivot axis. The third pivot axis is positioned at an angle relative to the first pivot axis and the second pivot axis. In some embodiments, the at least one lens comprises a first lens and a second lens, and the at least one opening comprises a first opening and a second opening.

According to some aspects of the present disclosure, a frame for spectacles is disclosed. The frame comprises a front portion having at least one opening configured to hold a lens, a first arm, and a second arm. A length of the front portion defines a longitudinal axis. The first arm is coupled to a first end of the front portion by a first hinge, and the first hinge defines a first rotational axis that is parallel to the longitudinal axis. The second arm is coupled to a second end of the front portion by a second hinge, and the second hinge defines a second rotational axis that is parallel the longitudinal axis. The first arm is configured to be rotated about the first rotational axis from a first position to a second position, and the second arm is configured to be rotated about the second rotational axis from a third position to a fourth position. The frame for spectacles is configured to be worn by a user when the first arm is in the first position and the second arm is in the third position and when the first arm is in the second position and the second arm is in the fourth position.

In some embodiments, the front portion comprises a first side comprising a first pattern and a second side comprising a second pattern. In some embodiments, the first pattern and the second pattern are different. In some embodiments, the frame further comprises a first connecting member that connects the first arm to the first hinge and a second connecting member that connects the second arm to the second hinge. The first connecting member is coupled to the first arm by a third hinge and coupled to the first end of the front portion by the first hinge. The second connecting member is coupled to the second arm by a fourth hinge and coupled to the second end of the front portion by the second hinge. In some embodiments, the first connecting member and the second connecting member are configured to rotate 190-204 degrees about the longitudinal axis. In some embodiments, the front portion has a pantoscopic tilt of 10 degrees when first arm is in the first position and the second arm is in the third position and when the first arm is in the second position and the second arm is in the fourth position. In some embodiments, the third hinge and the fourth hinge comprise one or more of integrated spring hinges, riveted hinges, and metal temples. In some embodiments, the longitudinal axis is substantially perpendicular to a third rotational axis defined by the third hinge and a fourth rotational axis defined by the fourth hinge. In some embodiments, a third rotational axis defined by the third hinge and a fourth rotational axis defined by the fourth hinge are substantially perpendicular to the length of the first arm and the length of the second arm, respectively. In some embodiments, the first hinge comprises a pin comprising a center portion and an arm that protrudes from the center portion, and the pin is configured to be inserted into an opening at the first end of the front portion. The first hinge further comprises a protruding member in the opening at the first end of the front portion, and the protruding member is configured to stop rotation of the pin in a first direction when the arm contacts the protruding member. In some embodiments, the second hinge comprises a pin comprising a center portion and an arm that protrudes from the center portion, and the pin is configured to be inserted into an opening at the second end of the front portion. The second hinge further comprises a protruding member in the opening at the second end of the front portion, wherein the protruding member is configured to stop rotation of the pin in a first direction when the arm contacts the protruding member.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates a front view of one example of a reversible frame for spectacles, according to various aspects of the disclosure.

FIG. 2 illustrates a top view of one example of a reversible frame for spectacles, according to various aspects of the disclosure.

FIG. 3 illustrates a side view of one example of a reversible frame for spectacles, according to various aspects of the disclosure.

FIG. 4A illustrates a front view of one example of a reversible frame for spectacles, according to various aspects of the disclosure.

FIG. 4B illustrates one example of a lens for spectacles, according to various aspects of the disclosure.

FIG. 5 illustrates a side view of one example of a reversible frame for spectacles in a first position, according to various aspects of the disclosure.

FIG. 6A illustrates a front view of one example of a first side of a front portion of spectacles, according to various aspects of the disclosure.

FIG. 6B illustrates a front view of one example of a second side of a front portion of spectacles, according to various aspects of the disclosure.

FIG. 6C illustrates a top view of one example of a front portion of spectacles, according to various aspects of the disclosure.

FIG. 7A illustrates one example of a hinge, according to various aspects of the disclosure.

FIG. 7B illustrates one example of components of a hinge, according to various aspects of the disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The present disclosure provides an improvement to conventional spectacle frames by providing a reversible frame with features designed and constructed to enable a user to wear one pair of spectacles with a first pattern or a second pattern visible to others and to easily switch back and forth between the two patterns.

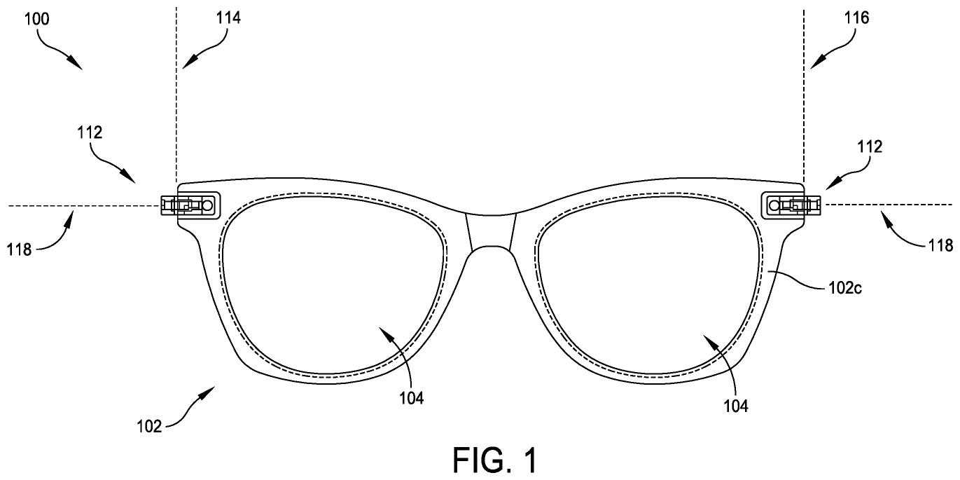

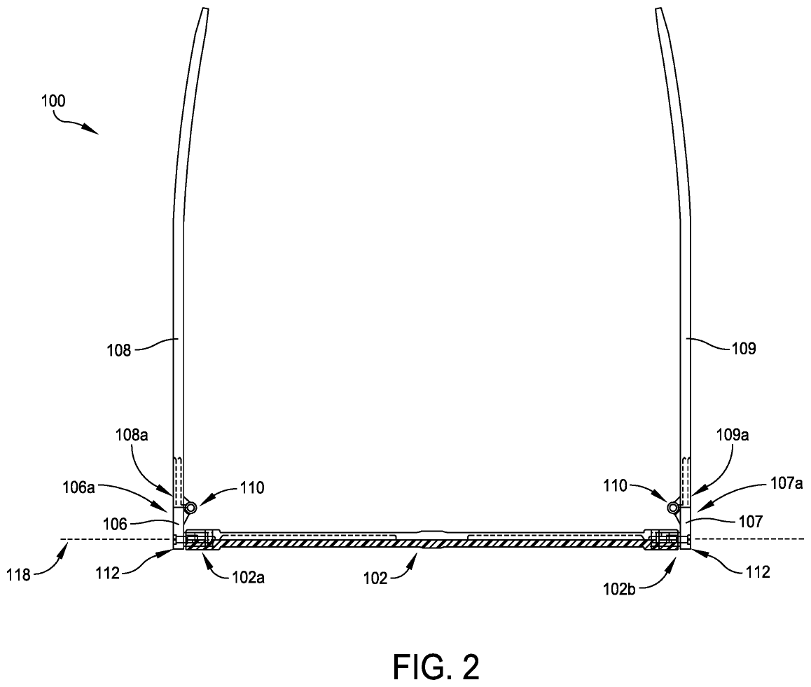

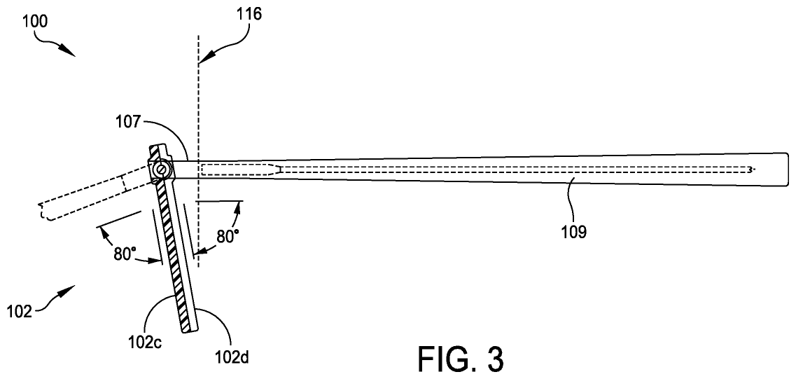

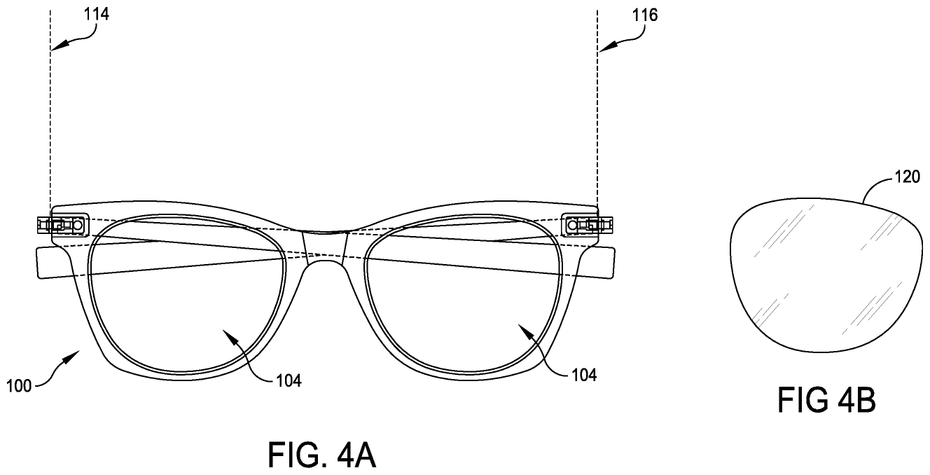

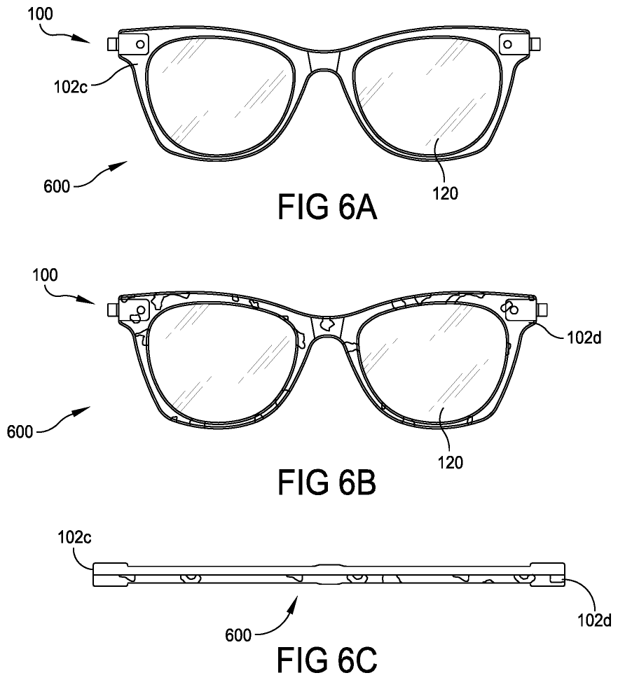

FIG. 1 illustrates one example of a front view of a reversible frame 100 for spectacles (e.g., eyeglasses such as eyeglasses with corrective, filtering, and/or polarizing lenses). FIG. 2 illustrates one example of a top view of reversible frame 100. FIG. 3 illustrates one example of a side view of reversible frame 100, showing various positions that the arms (e.g., arm 109) can be in. Reversible frame 100 comprises a front portion 102 having a first end 102a and a second end 102b as shown in FIG. 2. Front portion 102 includes a first side 102c and a second side 102d as best seen in FIG. 3. Front portion 102 has at least one opening 104 (e.g., two openings 104, as shown in FIG. 1) configured to hold a lens (e.g., lens 120 shown in FIG. 4B). In some embodiments, the front portion 102 comprises a first side 102c comprising a first pattern and a second side 102d comprising a second pattern, as illustrated in FIGS. 3 and 6A-6C. In some embodiments, the first pattern and the second pattern are different. For example, the first pattern may be a solid blue pattern, and the second pattern may be a tortoise pattern. However, it should be understood that other patterns may be used and that the first and second patterns may be the same.

As best seen in FIG. 2, frame 100 may also include a first connecting member 106, a second connecting member 107, a first arm 108, and a second arm 109. In some embodiments, first arm 108 and second arm 109 may be temple arms. Still referring to FIG. 2, a first arm 108 may have a first end 108a that is coupled to a first end 106a of a first connecting member 106 by a hinge 110. A second arm 109 may have a first end 109a that is coupled to a first end 107a of a second connecting member 107 by a hinge 110. In some embodiments, hinges 110 may comprise one or more of integrated spring hinges, riveted hinges, and metal temples.

Hinges 110 may enable the arms 108 and 109 to fold into a compact folded position, as shown in FIG. 4A. The first arm 108 may be rotatable, relative to the first connecting member 106, about a first pivot axis 114. The second arm 109 may be rotatable, relative to the second connecting member 107, about a second pivot axis 116. As illustrated in FIG. 1, the first pivot axis 114 and the second pivot axis 116 may be substantially parallel to each other. As illustrated in FIGS. 1 and 3, the first pivot axis 114 and the second pivot axis 116 may be positioned at an angle relative to a length of the first arm 108 and a length of the second arm 109, respectively. In some embodiments, the first pivot axis 114 and the second pivot axis 116 are substantially perpendicular to the length of the first arm 108 and the length of the second arm 109, respectively, as illustrated in FIG. 3. However, it should be understood that that the first pivot axis 114 and the second pivot axis 116 may be disposed at other angles relative to the lengths of the first arm 108 and second arm 109.

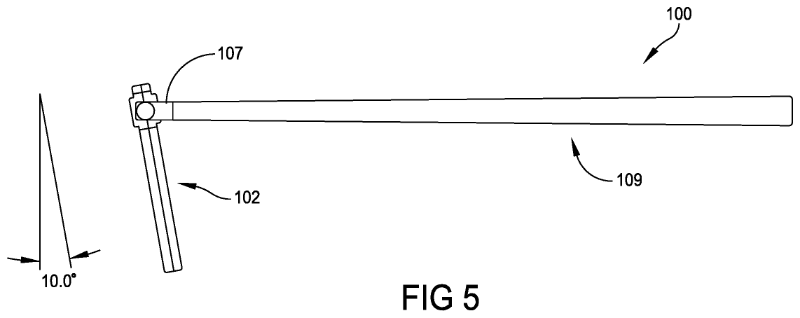

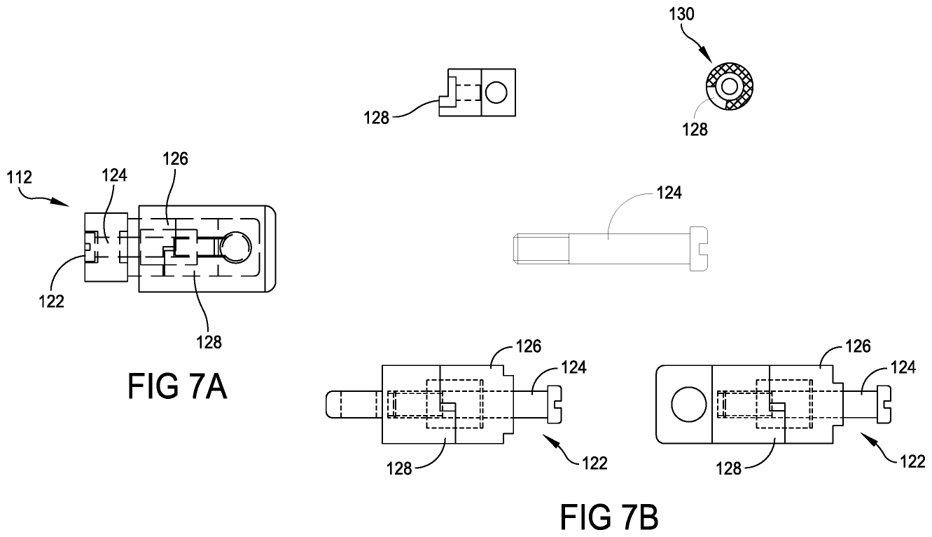

The first connecting member 106 may be coupled to a first end 102a of the front portion 102 by a hinge 112. The second connecting member 107 may be coupled to a second end 102b of the front portion 102 by a hinge 112. In FIGS. 1, 2, and 4A, some internal components of exemplary hinges 112 are shown in solid lines for ease of understanding how the hinges 112 function. More detailed views of the internal components of exemplary hinges 112 are shown in FIGS. 7A-7B. The first connecting member 106 and the second connecting member 107 may be rotatable, relative to the front portion 102, about a third pivot axis 118. The third pivot axis 118 may be positioned at an angle relative to the first pivot axis 114 and the second pivot axis 116. In some embodiments, the third pivot axis 118 is substantially perpendicular to the first pivot axis 114 and the second pivot axis 116, as illustrated in FIG. 1. However, the third pivot axis 118 may be arranged at other angles relative to at least one of the first pivot axis 114 and the second pivot axis 116. In some embodiments, the first connecting member 106 and the second connecting member 107 may be configured to rotate about the third pivot axis 118. In some embodiments, the first connecting member 106 and/or the second connecting member 107 may be able to rotate approximately 200 degrees about the third pivot axis 118 such that the frames may have a pantoscopic tilt angle of 10 degrees in a first configuration and a second configuration as shown in FIGS. 3 and 5. It should be understood that the amount of rotation about the third pivot axis may be varied to provide different pantoscopic tilts (e.g., 5°, 10°, 15°, 20°, etc.) when the frames are in the first and/or second configurations. In some embodiments, the frames may have a pantoscopic tilt angle in the range of 5-12 degrees in a first and second configuration. In some embodiments, the first connecting member 106 and/or the second connecting member 107 may be able to rotate between 190 degrees and 204 degrees about the third pivot axis 118. In some embodiments, the frames may have a pantoscopic tilt angle in the range of 0-20 degrees in a first and second configuration. In some embodiments, the first connecting member 106 and/or the second connecting member 107 may be able to rotate between 180 degrees and 220 degrees about the third pivot axis 118.

FIG. 3 illustrates one example of a degree of rotation available for connecting member 107 and arm 109 (as well as connecting member 106 and arm 108, not shown) about pivot axis 118. A user may begin with the frame 100 in a first position shown in FIG. 3, where the first side 102c of the front portion 102 would be displayed to others when the user is wearing the frame 100. Then a user could rotate connecting member 107 and arm 109 (as well as connecting member 106 and arm 108, not shown) counterclockwise 200 degrees to place the connecting member 107 and arm 109 (as well as connecting member 106 and arm 108, not shown) in a second position, where the second side 102d of the front portion 102 would be displayed to others when the user is wearing the frame 100. In some embodiments, the frame 100 may comprise a locking mechanism configured to maintain the connecting members 106, 107 and arms 108, 109 in the first position or the second position. The locking mechanism may comprise an interference or friction fit between parts, a detent, or other suitable structure for maintaining the connecting members 106, 107 and arms 108, 109 in the desired position. This provides a user with versatile frames that can feature two different designs in a matter of seconds. In another embodiment, a user could rotate connecting member 107 and arm 109 (as well as connecting member 106 and arm 108, not shown) clockwise 160 degrees to place the connecting member 107 and arm 109 (as well as connecting member 106 and arm 108, not shown) in a second position, where the second side 102d of the front portion 102 would be displayed to others when the user is wearing the frame 100.

In some embodiments, frame 100 may include a front portion 102, a first arm 108, and a second arm 109. A length of the front portion 102 may define a longitudinal axis. The first arm 108 may be coupled to the first end 102a of the front portion 102 by a first hinge (e.g., hinge 112), where the first hinge may define a first rotational axis that is parallel to the longitudinal axis. The second arm 109 may be coupled to the second end 102b of the front portion 102 by a second hinge (e.g., hinge 112), where the second hinge defines a second rotational axis that is parallel to the longitudinal axis. The first arm 108 may be configured to be rotated about the first rotational axis from a first position to a second position. The second arm 109 may be configured to be rotated about the second rotational axis from a third position (e.g., the position shown in FIG. 3) to a fourth position (e.g., 200 degrees Counterclockwise from the position shown in FIG. 3). The frame 100 may be configured to be worn by a user when first arm 108 is in the first position and the second arm 109 is in the third position (e.g., the position shown in FIG. 3) and when the first arm 108 is in the second position and the second arm 109 is in the fourth position (e.g., 200 degrees Counterclockwise from the position shown in FIG. 3).

In some embodiments, the frame 100 may further comprise a first connecting member (e.g., connecting member 106) that connects the first arm 108 to the first hinge (e.g., hinge 112). The first connecting member (e.g., connecting member 106) may be coupled to the first arm 108 by a third hinge (e.g., hinge 110) and coupled to the first end 102a of the front portion 102 by the first hinge (e.g., hinge 112). In some embodiments, the frame 100 may further comprise a second connecting member (e.g., connecting member 107) that connects the second arm 109 to the second hinge (e.g., hinge 112). The second connecting member (e.g., connecting member 107) may be coupled to the second arm 109 by a fourth hinge (e.g., hinge 110) and may be coupled to the second end 102b of the front portion 102 by the second hinge (e.g., hinge 112). In some embodiments, the third hinge (e.g., hinge 110) and the fourth hinge (e.g., hinge 110) may comprise one or more of integrated spring hinges, riveted hinges, and metal temples. In some embodiments, the first connecting member (e.g., connecting member 106) and the second connecting member (e.g., connecting member 107) may be configured to rotate between 190 degrees and 204 degrees about the longitudinal axis. In some embodiments, the longitudinal axis may be substantially perpendicular to a third rotational axis defined by the third hinge (e.g., hinge 110) and a fourth rotational axis defined by the fourth hinge (e.g., hinge 110). In some embodiments, the third rotational axis defined by the third hinge (e.g., hinge 110) and a fourth rotational axis defined by the fourth hinge (e.g., hinge 110) may be substantially perpendicular to the length of the first arm 108 and the length of the second arm 109, respectively. In some embodiments, the front portion 102 may have a pantoscopic tilt of 10 degrees when first arm 108 is in the first position and the second arm 109 is in the third position (as shown in FIG. 5) and when the first arm 108 is in the second position and the second arm 109 is in the fourth position (i.e., when arm 109 in FIG. 5 is rotated 200 degrees Counterclockwise).

FIG. 4A illustrates an exemplary front view of a reversible frame 100 for spectacles, where first arm 108 has been folded about pivot axis 114 and second arm 109 has been folded about pivot axis 116. FIG. 4B illustrates an exemplary lens 120 for spectacles, which is insertable into openings 104.

FIG. 5 illustrates a side view of a reversible frame 100 for spectacles in a first position, according to various aspects of the disclosure. In some embodiments, the front portion 102 may have a pantoscopic tilt of 10 degrees in a first position or orientation, as illustrated in FIG. 5. The first position or orientation may be a first position or orientation in which a user would wear the frame 100. In some embodiments, the front portion 102 may have a pantoscopic tilt of 5-12 degrees in the first position or orientation. It should be understood that the pantascopic tilt in the first position or orientation may be the same or different from the pantoscopic tilt in a second position or orientation.

FIG. 6A illustrates a front view of a first side 102c of a front portion 102 of a pair of spectacles 600, FIG. 6B illustrates a front view of a second side 102d of a front portion 102 of a pair of spectacles 600, and FIG. 6C illustrates a top view of the front portion 102 of spectacles 600, according to various aspects of the disclosure. Spectacles 600 may include at least one lens 120 (e.g., two lenses 120, as illustrated in FIGS. 6A and 6B) and a frame 100, as described above. In some embodiments, the at least one lens 120 may include a first lens 120 and a second lens 120. In some embodiments, the frame 100 may include a first opening 130 and a second opening 130. As illustrated in FIGS. 6A-6C, a first side 102c may comprise a first pattern (e.g., a solid blue pattern) and a second side 102d may comprise a second pattern (e.g., a tortoise pattern), and a user may easily change which pattern they are displaying based on their preference.

FIG. 7A illustrates a hinge 112 according to some embodiments, and FIG. 7B illustrates components of a hinge 112 according to some embodiments. In some embodiments, hinge 112 may include a pin 122 comprising a center portion 124 and an arm 126 that protrudes from the center portion 124. The pin 122 may be configured to be inserted into an opening 130 at the first end 102a of the front portion 102 or at the second end 102b of the front portion 102. In some embodiments, hinge 112 may include a protruding member 128 in the opening 130 at the first end 102a of the front portion 102 or at the second end 102b of the front portion 102. The protruding member 128 may be configured to stop rotation of the pin 122 in a first direction when the arm 126 contacts the protruding member 128. This prevents the connecting members 106 and 107 (and thus, arms 108 and 109) from rotating 360 degrees about the pivot axis 118 and instead limits the range of rotation such that a user can comfortably wear the frame 100 in two positions. For example, a user may begin by wearing the frame 100 in the position or orientation illustrated in FIG. 5. If the user decides to change which pattern they are displaying, the user may rotate the connecting members 106 and 107 (and thus, arms 108 and 109) counterclockwise from the position shown in FIG. 5 until the arm 126 in each hinge 112 contacts the protruding member 128 in each hinge and stops the rotation. The hinge 112 enables the connecting members 106 and 107 and arms 108 and 109 to rotate about the front portion 102, which allows a user to wear the reversible frame 100 with a first side of the front portion 102c visible to others and easily switch to wearing the reversible frame 100 with a second side of the front portion 102d visible to others. This makes the reversible frame 100 extremely versatile for users.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include”, “have”, or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration”. Any embodiment described herein as “exemplary” is not necessarily to be construed as preferred or advantageous over other embodiments.

A reference to an element in the singular is not intended to mean “one and only one” unless specifically stated, but rather “one or more”. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. Other variations are within the scope of the following claims.

What is claimed is:

1. A frame for spectacles, the frame comprising:
a front portion having at least one opening configured to hold a lens;
a first connecting member;
a second connecting member;
a first temple arm having a first end that is coupled to a first end of the first connecting member by a first hinge; and
a second temple arm having a first end that is coupled to a first end of the second connecting member by a second hinge;
wherein the first connecting member is coupled to a first end of the front portion by a third hinge, and wherein the second connecting member is coupled to a second end of the front portion by a fourth hinge,
wherein the first temple arm is rotatable, relative to the first connecting member, about a first pivot axis, and wherein the second temple arm is rotatable, relative to the second connecting member, about a second pivot axis,
wherein the first pivot axis and the second pivot axis are substantially parallel to each other and positioned at an angle relative to a length of the first temple arm and a length of the second temple arm, respectively,
wherein the first connecting member and the second connecting member are rotatable, relative to the front portion, about a third pivot axis, and
wherein the third pivot axis is positioned at an angle relative to the first pivot axis and the second pivot axis.

2. The frame of claim 1, wherein the front portion comprises a first side comprising a first pattern and a second side comprising a second pattern.

3. The frame of claim 2, wherein the first pattern and the second pattern are different.

4. The frame of claim 1, wherein the first connecting member and the second connecting member are configured to rotate 190-204 degrees about the third pivot axis.

5. The frame of claim 1, wherein the front portion has a pantoscopic tilt of 10 degrees in a first position.

6. The frame of claim 1, wherein the first hinge and the second hinge comprise one or more of integrated spring hinges, riveted hinges, and metal temples.

7. The frame of claim 1, wherein the third pivot axis is substantially perpendicular to the first pivot axis and the second pivot axis.

8. The frame of claim 1, wherein the first pivot axis and the second pivot axis are substantially perpendicular to the length of the first temple arm and the length of the second temple arm, respectively.

9. The frame of claim 1, wherein the third hinge comprises:
a pin comprising a center portion and an arm that protrudes from the center portion, wherein the pin is configured to be inserted into an opening at the first end of the front portion; and
a protruding member in the opening at the first end of the front portion, wherein the protruding member is configured to stop rotation of the pin in a first direction when the arm contacts the protruding member.

10. The frame of claim 1, wherein the fourth hinge comprises:
a pin comprising a center portion and an arm that protrudes from the center portion, wherein the pin is configured to be inserted into an opening at the second end of the front portion; and
a protruding member in the opening at the second end of the front portion, wherein the protruding member is configured to stop rotation of the pin in a first direction when the arm contacts the protruding member.

11. A pair of spectacles, comprising:
at least one lens; and
a frame, comprising:
a front portion having at least one opening configured to hold the at least one lens;
a first connecting member;
a second connecting member;
a first temple arm having a first end that is coupled to a first end of the first connecting member by a first hinge; and
a second temple arm having a first end that is coupled to a first end of the second connecting member by a second hinge;
wherein the first connecting member is coupled to a first end of the front portion by a third hinge, and wherein the second connecting member is coupled to a second end of the front portion by a fourth hinge,
wherein the first temple arm is rotatable, relative to the first connecting member, about a first pivot axis, and wherein the second temple arm is rotatable, relative to the second connecting member, about a second pivot axis,
wherein the first pivot axis and the second pivot axis are substantially parallel to each other and positioned at an angle relative to a length of the first temple arm and a length of the second temple arm, respectively,
wherein the first connecting member and the second connecting member are rotatable, relative to the front portion, about a third pivot axis, and
wherein the third pivot axis is positioned at an angle relative to the first pivot axis and the second pivot axis.

12. The pair of spectacles of claim 11, wherein the at least one lens comprises a first lens and a second lens, and the at least one opening comprises a first opening and a second opening.

13. A frame for spectacles, the frame comprising:
a front portion having at least one opening configured to hold a lens, wherein a length of the front portion defines a longitudinal axis;
a first arm coupled to a first end of the front portion by a first hinge, the first hinge defining a first rotational axis that is parallel to the longitudinal axis; and
a second arm coupled to a second end of the front portion by a second hinge, the second hinge defining a second rotational axis that is parallel the longitudinal axis,
wherein the first arm is configured to be rotated about the first rotational axis from a first position to a second position, and the second arm is configured to be rotated about the second rotational axis from a third position to a fourth position, and
wherein the frame for spectacles is configured to be worn by a user when first arm is in the first position and the second arm is in the third position and when the first arm is in the second position and the second arm is in the fourth position.

14. The frame of claim 13, wherein the front portion comprises a first side comprising a first pattern and a second side comprising a second pattern.

15. The frame of claim 14, wherein the first pattern and the second pattern are different.

16. The frame of claim 13, further comprising:
a first connecting member that connects the first arm to the first hinge; and
a second connecting member that connects the second arm to the second hinge,
wherein the first connecting member is coupled to the first arm by a third hinge and coupled to the first end of the front portion by the first hinge, and
wherein the second connecting member is coupled to the second arm by a fourth hinge and coupled to the second end of the front portion by the second hinge.

17. The frame of claim 16, wherein the first connecting member and the second connecting member are configured to rotate 190-204 degrees about the longitudinal axis.

18. The frame of claim 13, wherein the front portion has a pantoscopic tilt of 10 degrees when first arm is in the first position and the second arm is in the third position and when the first arm is in the second position and the second arm is in the fourth position.

19. The frame of claim 16, wherein the third hinge and the fourth hinge comprise one or more of integrated spring hinges, riveted hinges, and metal temples.

20. The frame of claim 16, wherein the longitudinal axis is substantially perpendicular to a third rotational axis defined by the third hinge and a fourth rotational axis defined by the fourth hinge.

21. The frame of claim 16, wherein a third rotational axis defined by the third hinge and a fourth rotational axis defined by the fourth hinge are substantially perpendicular to the length of the first arm and the length of the second arm, respectively.

22. The frame of claim 13, wherein the first hinge comprises:
a pin comprising a center portion and an arm that protrudes from the center portion, wherein the pin is configured to be inserted into an opening at the first end of the front portion; and
a protruding member in the opening at the first end of the front portion, wherein the protruding member is configured to stop rotation of the pin in a first direction when the arm contacts the protruding member.

23. The frame of claim 13, wherein the second hinge comprises:
a pin comprising a center portion and an arm that protrudes from the center portion, wherein the pin is configured to be inserted into an opening at the second end of the front portion; and
a protruding member in the opening at the second end of the front portion, wherein the protruding member is configured to stop rotation of the pin in a first direction when the arm contacts the protruding member.
